(19) United States
(12) Patent Application Publication
(10) Pub. No.: US 2013/0210633 A1
(43) Pub. Date: Aug. 15, 2013

(54) METHOD FOR REDUCING WATER STRESS IN PLANTS

(71) Applicants: Asako Nagasawa, Takarazuka-shi (JP); Fujio Mukumoto, Takarazuka-shi (JP)

(72) Inventors: Asako Nagasawa, Takarazuka-shi (JP); Fujio Mukumoto, Takarazuka-shi (JP)

(73) Assignee: SUMITOMO CHEMICAL COMPANY, LIMITED, Tokyo (JP)

(21) Appl. No.: 13/823,665

(22) PCT Filed: Sep. 30, 2011
(86) PCT No.: PCT/JP2011/073152

§ 371 Date: May 1, 2013

(30) Foreign Application Priority Data
Oct. 4, 2010 (JP) 2010-224573
Apr. 8, 2011 (JP) 2011-086131

(51) Int. Cl. A01N 43/38; A01N 37/44

(52) U.S. Cl. CPC A01N 43/38; A01N 37/44
USPC 504/284; 504/322; 504/315

(57) ABSTRACT

The present invention provides: a method for reducing water stress in a plant which comprises applying an effective amount of one or more compounds selected from the group consisting of a compound represented by the formula (I) and agriculturally acceptable salts thereof to a plant that has been exposed to or to be exposed to water stress conditions; and so on.

### TECHNICAL FIELD

The present invention relates to a method for reducing water stress in plants.

### BACKGROUND ART

When plants are exposed to conditions where reduced water content in the soil due to a shortage of rainfall or irrigation leads to impaired water absorption, what could be called drought stress conditions, or conditions where increased water content in the soil due to excess rainfall or irrigation results in excessive moisture around the roots, what could be called excessive moisture stress conditions, physiological functions of cells may deteriorate and thus various disorders may arise in the plant. While it has been known that phytohormones and some chemical substances such as plant growth regulators have effects on plants in reducing water stress such as drought stress or excessive moisture stress (Journal of Plant Growth Regulation (2010) 29: 366-374), those effects are not necessarily satisfactory in practice.

### DISCLOSURE OF INVENTION

An object of the present invention is to provide a method for reducing water stress in plants, and so on.

The present invention is based on the finding that an application of a specific compound to a plant can reduce water stress in the plant when the plant is exposed to water stress conditions.

That is, the present invention provides:

[1] A method for reducing water stress in a plant which comprises applying an effective amount of one or more compounds selected from the group consisting of a compound represented by the formula (I) and agriculturally acceptable salts thereof (hereinafter, sometimes referred to as the present compound) to a plant that has been exposed to or to be exposed to water stress conditions (hereinafter, sometimes referred to as the method of the present invention):

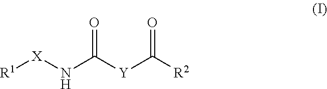

wherein

R¹ represents a phenyl group, a naphthyl group or an aromatic heterocyclic group, and these groups are optionally substituted with 1 to 5 members selected from among a halogen atom, a hydroxyl group, a cyano group, a nitro group, a C1-C6 alkyl group optionally substituted with one or more halogen atoms, a C1-C6 alkoxy group optionally substituted with one or more halogen atoms, a C1-C6 alkylthio group optionally substituted with one or more halogen atoms, a C2-C6 alkenyl group optionally substituted with one or more halogen atoms, a C2-C6 alkynyl group optionally substituted with one or more halogen atoms, an amino group, a C1-C6 alkylamino group and a di(C1-C6 alkyl)amino group;

R² represents a hydroxyl group, an amino group, or a C1-C6 alkoxy group;

X represents a linear or branched C1-C6 alkylene group; and

Y represents a linear or branched C1-C6 alkylene group, or a linear or branched C2-C6 alkenylene group;

[2] The method according to the item [1], wherein in the formula (I),

R¹ is a phenyl group, a 1-naphthyl group or a 3-indolyl group, wherein one or more hydrogen atoms in these groups are optionally replaced by 1 to 5 members selected from among a halogen atom, a hydroxyl group, a nitro group, a C1-C6 alkyl group and a C1-C6 alkoxy group;

R² is a hydroxyl group, an amino group or a C1-C6 alkoxy group;

X is a linear or branched C1-C6 alkylene group; and

Y is a linear or branched C1-C6 alkylene group, or a linear or branched C2-C6 alkenylene group;

[3] The method according to the item [1], wherein in the formula (I),

R¹ is a phenyl group, a 4-iodophenyl group, a 1-naphthyl group or a 3-indolyl group;

R² is a hydroxyl group or a methoxy group;

X is an ethylene group or a tetramethylene group; and

Y is an ethylene group or a trimethylene group;

[4] The method according to the item [1], wherein the compound of the formula (I) is a compound selected from among the following compounds:

(1) 4-oxo-4-(2-phenylethyl)aminobutyric acid (hereinafter, sometimes referred to as the compound A),

(2) methyl 4-oxo-4-(4-phenylbutyl)aminobutyrate (hereinafter, sometimes referred to as the compound B),

(3) methyl 4-oxo-4-(2-phenylethyl)aminobutyrate (hereinafter, sometimes referred to as the compound C),

(4) 4-oxo-4-(4-phenylbutyl)aminobutyric acid (hereinafter, sometimes referred to as the compound D),

(5) 5-oxo-5-[2-(3-indolyl)ethyl]aminovaleric acid (hereinafter, sometimes referred to as the compound E),

(6) 5-oxo-5-[(1-naphthyl)methyl]aminovaleric acid (hereinafter, sometimes referred to as the compound F), and

(7) methyl 4-oxo-4-[2-(4-iodophenyl)ethyl]aminobutyrate (hereinafter, sometimes referred to as the compound G);

[5] The method according to any one of the items [1] to [4], wherein the method of the application is a seed treatment;

[6] The method according to the item [5], wherein the seed treatment is a seed treatment of treating with the present compound in an amount of from 1 to 30 g per 100 kg of seeds;

[7] The method according to any one of the items [1] to [6], wherein the plant is rice, corn, soybean or wheat;

[8] The method according to any one of the items [1] to [7], wherein the plant is a transgenic plant;

[9] The method according to any one of the items [1] to [8], wherein the water stress is drought stress;

[10] The method according to any one of the items [1] to [8], wherein the water stress is excessive moisture stress;

[11] The method according to any one of the items [1] to [10], wherein the water stress is indicated by a change in one or more of the following plant phenotypes:

(1) germination percentage,
(2) seedling establishment rate,
(3) number of healthy leaves,
(4) plant length,
(5) plant weight,
(6) leaf area,
(7) leaf color,
(8) number or weight of seeds or fruits,
(9) quality of harvests,
(10) flower setting rate or fruit setting rate,
(11) chlorophyll fluorescence yield,
(12) water content,
(13) leaf surface temperature, and
(14) transpiration capacity;

[12] Use of one or more compounds selected from the group consisting of the compound represented by the formula (I) of [1] and agriculturally acceptable salts thereof for reducing water stress in a plant; and

[13] The use according to the item [12], wherein the water stress is indicated by a change in one or more of the following plant phenotypes:

(1) germination percentage,
(2) seedling establishment rate,
(3) number of healthy leaves,
(4) plant length,
(5) plant weight,
(6) leaf area,
(7) leaf color,
(8) number or weight of seeds or fruits,
(9) quality of harvests,
(10) flower setting rate or fruit setting rate,
(11) chlorophyll fluorescence yield,
(12) water content,
(13) leaf surface temperature, and
(14) transpiration capacity.

Use of the method of the present invention enables reduction of water stress in plants.

### MODE FOR CARRYING OUT THE INVENTION

In the present invention, “water stress” includes drought stress and excessive moisture stress. The “drought stress” can be induced in plants under conditions where reduced water content in the soil due to a shortage of rainfall or irrigation leads to impaired water absorption, and the “excessive moisture stress” can be induced in plants under conditions where increased water content in the soil due to excess rainfall or irrigation results in excessive moisture around the roots. The water stress may trigger in plants deterioration of physiological functions of cells, thereby leading to various disorders.

While the conditions which induce drought stress may vary depending on the kind of the soil where plants are cultivated, examples of the conditions include: the water content in the soil of 15% by weight or less, more severely 10% by weight or less, and still more severely 7.5% by weight or less; or the pF value of the soil of 2.3 or more, more severely 2.7 or more, and still more severely 3.0 or more.

While the conditions which induce the excessive moisture stress may vary depending on the kind of the soil where plants are cultivated, examples of the conditions include: the water content in the soil of 30% by weight or more, more severely 40% by weight or more, and still more severely 50% by weight or more; or the pF value of the soil of 1.7 or less, more severely 1.0 or less, and still more severely 0.3 or less. AS used herein, the pF value is a value defined in the “Method for pF Value Measurement” on pages 61 and 62 of “Dojyo, Shokubutsu Eiyo, Kankyo Jiten (Encyclopedia of Soil, Plant Nutrition and Environment)” (TAIYOSHA Co., Ltd., 1994, Matsuzaka et al.).

The water stress in plants can be recognized by comparing a change in plant phenotypes described below between plants which have been exposed to water stress conditions and plants which have not been exposed to the same water stress conditions. That is, the following plant phenotypes serve as indicators of the water stress in plants:

### <Plant Phenotypes>

(1) germination percentage,
(2) seedling establishment rate,
(3) number of healthy leaves,
(4) plant length,
(5) plant weight,
(6) leaf area,
(7) leaf color,
(8) number or weight of seeds or fruits,
(9) quality of harvests,
(10) flower setting rate or fruit setting rate,
(11) chlorophyll fluorescence yield,
(12) water content,
(13) leaf surface temperature, and
(14) transpiration capacity.

In the present specification, the water stress may be quantified as the “intensity of stress” represented by the following equation.

“Intensity of stress”=100×“any one of plant phenotypes in plants which have not been exposed to water stress”/“the plant phenotype in plants which have been exposed to water stress” Equation:

The method of the present invention is applied to plants that have been exposed to or to be exposed to water stress conditions whose “intensity of stress” represented by the above equation is from 105 to 450, preferably from 110 to 200, and more preferably from 115 to 160.

In a plant exposed to water stress conditions, an influence may be recognized on at least one of the above phenotypes. That is, observed is:

(1) decrease in germination percentage,
(2) decrease in seedling establishment rate,
(3) decrease in number of healthy leaves,
(4) decrease in plant length,
(5) decrease in plant weight,
(6) decrease in leaf area increasing rate,
(7) leaf color fading,
(8) decrease in number or weight of seeds or fruits,
(9) deterioration in quality of harvests,
(10) decrease in flower setting rate or fruit setting rate,
(11) decrease in chlorophyll fluorescence yield,
(12) decrease in water content,
(13) increase in leaf surface temperature, or
(14) decrease in transpiration capacity, among others, and the magnitude of the water stress in the plant can be measured using that as an indicator. The present invention is directed to a method for reducing water stress in a plant that has been exposed to or to be exposed to water stress conditions by applying the present compound to the plant. The effect of reducing the water stress can be evaluated by comparing the above indicators between a plant treated with the present compound and a plant which has not been treated after the plants are exposed to the water stress conditions.

Stages in which target plants in the present invention can be exposed to the water stress conditions include all growth stages of plants, including a germination period, a vegetative growing period, a reproductive growing period and a harvesting period.

The application period of the present compound used in the present invention may be any growth stage of plants, and examples thereof include the germination period such as before seeding, at the time of seeding, and after seeding and before or after emergence; the vegetative growing period such as at the time of seedling raising, at the time of seedling transplantation, at the time of cuttage or sticking, or at the time of growing after settled planting; the reproductive growing period such as before blooming, during blooming, after blooming, immediately before earing or during the earing period; and the harvesting period such as before harvesting plan, before ripening plan, or a coloration initiation period of fruits. Plants to which the present compound is to be applied may be plants which have been exposed to or to be exposed to the water stress conditions. That is, the compound can also be preventively applied to plants before being exposed to the water stress conditions in addition to plants which have been exposed to the water stress conditions.

The present compound used in the method of the present invention is one or more compounds selected from the group consisting of a compound represented by the following formula (I):

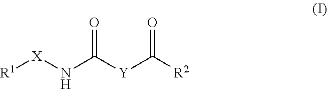

wherein

R¹ represents a phenyl group, a naphthyl group or an aromatic heterocyclic group, and these groups are optionally substituted with 1 to 5 members selected from among a halogen atom, a hydroxyl group, a cyano group, a nitro group, a C1-C6 alkyl group optionally substituted with one or more halogen atoms, a C1-C6 alkoxy group optionally substituted with one or more halogen atoms, a C1-C6 alkylthio group optionally substituted with one or more halogen atoms, a C2-C6 alkenyl group optionally substituted with one or more halogen atoms, a C2-C6 alkynyl group optionally substituted with one or more halogen atoms, an amino group, a C1-C6 alkylamino group and a di(C1-C6 alkyl)amino group;

R² represents a hydroxyl group, an amino group, or a C1-C6 alkoxy group;

X represents a linear or branched C1-C6 alkylene group; and

Y represents a linear or branched C1-C6 alkylene group, or a linear or branched C2-C6 alkenylene group;

and agriculturally acceptable salts thereof.

The compound represented by the formula (I) is a compound described in Japanese Patent Publication No. 4087942 or Japanese Unexamined Patent Publication No. 2001-139405 and can be synthesized, for example, by the method described in the publications.

The present compound is preferably one or more compounds selected from the group consisting of the compound of the formula (I), wherein in the formula (I),

R¹ is a phenyl group, a 1-naphthyl group or a 3-indolyl group, wherein one or more hydrogen atoms in these groups are optionally replaced by 1 to 5 members selected from among a halogen atom, a hydroxyl group, a nitro group, a C1-C6 alkyl group and a C1-C6 alkoxy group;

R² is a hydroxyl group, an amino group or a C1-C6 alkoxy group;

X is a linear or branched C1-C6 alkylene group; and

Y is a linear or branched C1-C6 alkylene group, or a linear or branched C2-C6 alkenylene group;

and agriculturally acceptable salts thereof.

The present compound is more preferably one or more compounds selected from the group consisting of the compound of the formula (I), wherein in the formula (I),

R¹ is a phenyl group, a 4-iodophenyl group, a 1-naphthyl group or a 3-indolyl group;

R² is a hydroxyl group or a methoxy group;

X is an ethylene group or a tetramethylene group; and

Y is an ethylene group or a trimethylene group; and agriculturally acceptable salts thereof.

Specific examples of the present compound include:

(1) 4-oxo-4-(2-phenylethyl)aminobutyric acid,
(2) methyl 4-oxo-4-(4-phenylbutyl)aminobutyrate,
(3) methyl 4-oxo-4-(2-phenylethyl)aminobutyrate,
(4) 4-oxo-4-(4-phenylbutyl)aminobutyric acid,
(5) 5-oxo-5-[2-(3-indolyl)ethyl]aminovaleric acid,
(6) 5-oxo-5-[(1-naphthyl)methyl]aminovaleric acid, and
(7) methyl 4-oxo-4-[2-(4-iodophenyl)ethyl]aminobutyrate,
and the compound is preferable from the viewpoint that it is capable of effectively reducing water stress of plants.

The present compound may be a salt with a base. Examples of a basic salt of the compound represented by the formula (I) include the followings:

metal salts such as alkali metal salts and alkaline earth metal salts, including salts of sodium, potassium or magnesium;

salts with ammonia; and

salts with organic amines such as morpholine, piperidine, pyrrolidine, mono-lower alkylamine, di-lower alkylamine, tri-lower alkylamine, monohydroxy lower alkylamine, dihydroxy lower alkylamine and trihydroxy lower alkylamine.

The present compound used in the method of the present invention can be used alone, or used after being formulated using various inert ingredients as described hereinafter.

Examples of the solid carrier used in formulation include fine powders or granules such as minerals such as kaolin clay, attapulgite clay, bentonite, montmorillonite, acid white clay, pyrophyllite, talc, diatomaceous earth and calcite; natural organic materials such as corn rachis powder and walnut husk powder; synthetic organic materials such as urea; salts such as calcium carbonate and ammonium sulfate; synthetic inorganic materials such as synthetic hydrated silicon oxide; and as a liquid carrier, aromatic hydrocarbons such as xylene, alkylbenzene and methylnaphthalene; alcohols such as 2-propanol, ethyleneglycol, propylene glycol, and ethylene glycol monoethyl ether; ketones such as acetone, cyclohexanone and isophorone; vegetable oil such as soybean oil and cotton seed oil; petroleum aliphatic hydrocarbons, esters, dimethylsulfoxide, acetonitrile and water.

Examples of the surfactant include anionic surfactants such as alkyl sulfate ester salts, alkylaryl sulfonate salts, dialkyl sulfosuccinate salts, polyoxyethylene alkylaryl ether phosphate ester salts, lignosulfonate salts and naphthalene sulfonate formaldehyde polycondensates; and nonionic surfactants such as polyoxyethylene alkyl aryl ethers, polyoxyethylene alkylpolyoxypropylene block copolymers and sorbitan fatty acid esters and cationic surfactants such as alkyltrimethylammonium salts.

Examples of the other formulation auxiliary agents include water-soluble polymers such as polyvinyl alcohol and polyvinylpyrrolidone, polysaccharides such as Arabic gum, alginic acid and the salt thereof, CMC (carboxymethyl-cellulose), Xanthan gum, inorganic materials such as aluminum magnesium silicate and alumina sol, preservatives, coloring agents and stabilization agents such as PAP (acid phosphate isopropyl) and BHT.

The method of the present invention is usually carried out by applying an effective amount of the present compound to plants or growing sites of plants. The plant to which the present compound is to be applied may be various forms or sites, such as foliages, buds, flowers, fruits, ears or spikes, seeds, bulbs, stem tubers, roots and seedlings. As used herein, bulbs mean discoid stem, corm, rhizoma, root tuber and rhizophore. In the present specification, the seedlings include cutting and sugar cane stem cutting. Examples of the growing sites of plants include soil before or after sowing plants.

When the present compound is applied to plants or growing sites of plants, the present compound is applied to the target plants once or more.

Specific examples of the application method in the method of the present invention include treatment of foliages, floral organs or ears or spikes of plants, such as foliage spraying; treatment of seeds, such as seed sterilization, seed immersion or seed coating; treatment of seedlings; treatment of bulbs; and treatment of cultivation lands of plants, such as soil treatment. Among these application methods, preferred are treatment of seeds and treatment of bulbs.

The compound may be applied only to specific sites of plants, such as floral organ in the blooming season including before blooming, during blooming and after blooming, and the ear or spike in the earing season, or may be applied to entire plants.

Examples of the soil treatment method in the method of the present invention include spraying onto the soil, soil incorporation, and perfusion of a chemical liquid into the soil (irrigation of chemical liquid, soil injection, and dripping of chemical liquid). Examples of the place to be treated include planting hole, furrow, around a planting hole, around a furrow, entire surface of cultivation lands, the parts between the soil and the plant, area between roots, area beneath the trunk, main furrow, growing soil, seedling raising box, seedling raising tray and seedbed. Examples of the treating period include before seeding, at the time of seeding, immediately after seeding, raising period, before settled planting, at the time of settled planting, and growing period after settled planting. In the above soil treatment, two or more kinds of present compounds may be simultaneously applied to the plant, or a solid fertilizer such as a paste fertilizer containing the present compound may be applied to the soil. Also, the present compound may be mixed in an irrigation liquid, and, examples thereof include injecting to irrigation facilities (irrigation tube, irrigation pipe, sprinkler, etc.), mixing into the flooding liquid between furrows, mixing into a hydroponic medium and the like. Alternatively, an irrigation liquid may be mixed with the present compound in advance and, for example, used for treatment by an appropriate irrigating method including the irrigation method mentioned above and the other methods such as sprinkling and flooding. Alternatively, the present compound can be applied by winding a crop with a resin formulation processed into a sheet or a string, putting a string of the resin formulation around a crop so that the crop is surrounded by the string, and/or laying a sheet of the resin formulation on the soil surface near the root of a crop.

Examples of the method of treating seeds or method of treating bulbs in the method of the present invention include a method for treating seeds or bulbs of a plant with the present compound, and specific examples thereof include a spraying treatment in which a suspension of the present compound is atomized and sprayed on the seed surface or the bulb surface, a smearing treatment in which a wettable powder, an emulsion or a flowable agent of the present compound is applied to seeds or bulbs with a small amount of water added or applied as it is without dilution, an immersing treatment in which seeds are immersed in a solution of the present compound for a certain period of time, film coating treatment, and pellet coating treatment.

Examples of the treatment of seedlings in the method of the present invention include spraying treatment of spraying to the entire seedlings a dilution having a proper concentration of active ingredients prepared by diluting the present compound with water, immersing treatment of immersing seedlings in the dilution, and coating treatment of adhering the present compound formulated into a dust formulation to the entire seedlings. Examples of the method of treating the soil before or after sowing seedlings include a method of spraying a dilution having a proper concentration of active ingredients prepared by diluting the present compound with water to seedlings or the soil around seedlings after sowing seedlings, and a method of spraying the present compound formulated into a solid formulation such as a granule to soil around seedlings after sowing seedlings.

The present compound may be mixed with a hydroponic medium in hydroponics, and may also be used as one of culture medium components in tissue culture. When the present compound is used for hydroponics, it can be dissolved or suspended in a conventionally used culture medium for hydroponics, such as ENSHI, at a concentration within a range from 0.001 to 10,000 ppm. When the present compound is used at the time of tissue culture or cell culture, it can be dissolved or suspended in a conventionally used culture medium for plant tissue culture, such as an MS culture medium, at a concentration within a range from 0.001 to 10,000 ppm. In this case, in accordance with a usual method, saccharides as a carbon source, various phytohormones and the like can be appropriately added.

When the present compound is used for treatment of plants or growing sites of plants, the treatment amount can vary according to the kind of plants to be treated, formulation form, treating period and meteorological conditions, but is usually within a rang from 0.1 to 1,000 g, and preferably from 1 to 500 g, in terms of an active ingredient amount, per 1,000 m². When the present compound is incorporated into the entire soil, the treatment amount is usually within a range from 0.1 to 1,000 g, and preferably from 1 to 500 g, per 1,000 m². At this time, an emulsion, a wettable powder, a flowable agent and a microcapsule are usually used for the treatment by spraying after dilution with water. In this case, the concentration of the present compound is usually within a range from 0.01 to 10,000 ppm, and preferably from 1 to 5,000 ppm. A dust formulation and a granule are usually used for the treatment as they are without dilution.

In the treatment of seeds or the treatment of bulbs, the weight of the present compound per 100 kg of seeds is usually within a range from 0.1 to 100 g, and preferably from 1 to 30 g. Examples of the seeds or bulbs used in the present treatment include those having a weight of 100 g or less, preferably 20 g or less, more preferably 0.5 g or less, and still more preferably 50 mg or less. Examples of the seeds or bulbs preferably include soybean, corn, rice and wheat, and more preferably rice and wheat, among others.

In the treatment of seedlings, the weight of the present compound per seedling is usually within a range from 0.01 to 20 mg, and preferably from 0.5 to 8 mg. In the treatment of the soil before or after sowing seedlings, the weight of the present compound per 1,000 m² is usually within a range from 0.1 to 100 g, and preferably from 1 to 50 g.

Examples of plants in which water stress can be reduced by the present invention include the followings.

crops: corn, rice, wheat, barley, rye, oat, sorghum, cotton, soybean, peanut, buckwheat, beet, canola, rapeseed, sunflower, sugar cane, tobacco, and pea, etc.;

vegetables: solanaceous vegetables (eggplant, tomato, pimento, pepper, potato, etc.), cucurbitaceous vegetables (cucumber, pumpkin, zucchini, water melon, melon, squash, etc.), cruciferous vegetables (Japanese radish, white turnip, horseradish, kohlrabi, Chinese cabbage, cabbage, leaf mustard, broccoli, cauliflower, etc.), asteraceous vegetables (burdock, crown daisy, artichoke, lettuce, etc.), liliaceous vegetables (green onion, onion, garlic, and asparagus), ammiaceous vegetables (carrot, parsley, celery, parsnip, etc.), chenopodiaceous vegetables (spinach, Swiss chard, etc.), lamiaceous vegetables (Perilla frutescens, mint, basil, etc.), strawberry, sweet potato, Dioscorea japonica, colocasia, etc.;

flowers;

foliage plants;

turf grasses;

fruits: pomaceous fruits (apple, pear, Japanese pear, Chinese quince, quince, etc.), stone fleshy fruits (peach, plum, nectarine, Prunus mume, cherry fruit, apricot, prune, etc.), citrus fruits (Citrus unshiu, orange, lemon, rime, grapefruit, etc.), nuts (chestnuts, walnuts, hazelnuts, almond, pistachio, cashew nuts, macadamia nuts, etc.), berries (blueberry, cranberry, blackberry, raspberry, etc.), grape, kaki fruit, olive, Japanese plum, banana, coffee, date palm, coconuts, etc.; and

trees other than fruit trees; tea, mulberry, flowering plant, roadside trees (ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate), etc.

Examples of plants in which water stress can be reduced by the present invention preferably include rice, corn, soybean and wheat.

The aforementioned “plants” include plants, to which resistance to HPPD inhibitors such as isoxaflutole, ALS inhibitors such as imazethapyr or thifensulfuron-methyl, EPSP synthetase inhibitors such as glyphosate, glutamine synthetase inhibitors such as the glufosinate, acetyl-CoA carboxylase inhibitors such as sethoxydim, and herbicides such as bromoxynil, dicamba, 2,4-D, etc. has been conferred by a classical breeding method or genetic engineering technique.

Examples of a “plant” on which resistance has been conferred by a classical breeding method include rape, wheat, sunflower and rice resistant to imidazolinone ALS inhibitory herbicides such as imazethapyr, which are already commercially available under a product name of Clearfield (registered trademark). Similarly, there is soybean on which resistance to sulfonylurea ALS inhibitory herbicides such as thifensulfuron-methyl has been conferred by a classical breeding method, which is already commercially available under a product name of STS soybean. Similarly, examples on which resistance to acetyl-CoA carboxylase inhibitors such as trione oxime or aryloxy phenoxypropionic acid herbicides has been conferred by a classical breeding method include SR corn. The plant on which resistance to acetyl-CoA carboxylase inhibitors has been conferred is described in Proceedings of the National Academy of Sciences of the United States of America (Proc. Natl. Acad. Sci. USA), vol. 87, pp. 7175-7179 (1990). A variation of acetyl-CoA carboxylase resistant to an acetyl-CoA carboxylase inhibitor is reported in Weed Science, vol. 53, pp. 728-746 (2005) and a plant resistant to acetyl-CoA carboxylase inhibitors can be generated by introducing a gene of such an acetyl-CoA carboxylase variation into a plant by genetically engineering technology, or by introducing a variation conferring resistance into a plant acetyl-CoA carboxylase. Furthermore, plants resistant to acetyl-CoA carboxylase inhibitors or ALS inhibitors or the like can be generated by introducing a site-directed amino acid substitution variation into an acetyl-CoA carboxylase gene or the ALS gene of the plant by introduction a nucleic acid into which has been introduced a base substitution variation represented Chimeraplasty Technique (Gura T. 1999. Repairing the Genome's Spelling Mistakes. Science 285: 316-318) into a plant cell.

Examples of a plant on which resistance has been conferred by genetic engineering technology include corn, soybean, cotton, rape, sugar beet resistant to glyphosate, which is already commercially available under a product name of RoundupReady (registered trademark), AgrisureGT, etc. Similarly, there are corn, soybean, cotton and rape which are made resistant to glufosinate by genetic engineering technology, a kind, which is already commercially available under a product name of LibertyLink (registered trademark). A cotton made resistant to bromoxynil by genetic engineering technology is already commercially available under a product name of BXN likewise.

The aforementioned “plants” include genetically engineered crops produced using such genetic engineering techniques, which, for example, are able to synthesize selective toxins as known in genus Bacillus.

Examples of toxins expressed in such genetically engineered crops include: insecticidal proteins derived from Bacillus cereus or Bacillus popilliae; δ-endotoxins such as Cry1Ab, Cry1Ac, Cry1F, Cry1Fa2, Cry2Ab, Cry3A, Cry3Bb1 or Cry9C, derived from Bacillus thuringiensis; insecticidal proteins such as VIP1, VIP2, VIP3, or VIP3A; insecticidal proteins derived from nematodes; toxins generated by animals, such as scorpion toxin, spider toxin, bee toxin, or insect-specific neurotoxins; mold fungi toxins; plant lectin; agglutinin; protease inhibitors such as a trypsin inhibitor, a serine protease inhibitor, patatin, cystatin, or a papain inhibitor; ribosome-inactivating proteins (RIP) such as lycine, corn-RIP, abrin, luffin, saporin, or briodin; steroid-metabolizing enzymes such as 3-hydroxysteroid oxidase, ecdysteroid-UDP-glucosyl transferase, or cholesterol oxidase; an ecdysone inhibitor; HMG-COA reductase; ion channel inhibitors such as a sodium channel inhibitor or calcium channel inhibitor; juvenile hormone esterase; a diuretic hormone receptor; stilbene synthase; bibenzyl synthase; chitinase; and glucanase.

Toxins expressed in such genetically engineered crops also include: hybrid toxins of δ-endotoxin proteins such as Cry1Ab, Cry1Ac, Cry1F, Cry1Fa2, Cry2Ab, Cry3A, Cry3Bb1, Cry9C, Cry34Ab or Cry35Ab and insecticidal proteins such as VIP1, VIP2, VIP3 or VIP3A; partially deleted toxins; and modified toxins. Such hybrid toxins are produced from a new combination of the different domains of such proteins, using a genetic engineering technique. As a partially deleted toxin, Cry1Ab comprising a deletion of a portion of an amino acid sequence has been known. A modified toxin is produced by substitution of one or multiple amino acids of natural toxins.

Examples of such toxins and genetically engineered plants capable of synthesizing such toxins are described in EP-A-0 374 753, WO 93/07278, WO 95/34656, EP-A-0 427 529, EP-A-451 878, WO 03/052073, etc.

Toxins contained in such genetically engineered plants are able to confer resistance particularly to insect pests belonging to Coleoptera, Hemiptera, Diptera, Lepidoptera and Nematodes, to the plants.

Genetically engineered plants, which comprise one or multiple insecticidal pest-resistant genes and which express one or multiple toxins, have already been known, and some of such genetically engineered plants have already been on the market. Examples of such genetically engineered plants include YieldGard (registered trademark) (a corn variety for expressing Cry1Ab toxin), YieldGard Rootworm (registered trademark) (a corn variety for expressing Cry3Bb1 toxin), YieldGard Plus (registered trademark) (a corn variety for expressing Cry1Ab and Cry3Bb1 toxins), Herculex I (registered trademark) (a corn variety for expressing phosphinotricine N-acetyl transferase (PAT) so as to confer resistance to Cry1Fa2 toxin and glufosinate), NuCOTN33B (registered trademark) (a cotton variety for expressing Cry1Ac toxin), Bollgard I (registered trademark) (a cotton variety for expressing Cry1Ac toxin), Bollgard II (registered trademark) (a cotton variety for expressing Cry1Ac and Cry2Ab toxins), VIPCOT (registered trademark) (a cotton variety for expressing VIP toxin), NewLeaf (registered trademark) (a potato variety for expressing Cry3A toxin), NatureGard (registered trademark) Agrisure (registered trademark) GT Advantage (GA21 glyphosate-resistant trait), Agrisure (registered trademark) CB Advantage (Btll corn borer (CB) trait), and Protecta (registered trademark).

The aforementioned “plants” also include crops produced using a genetic engineering technique, which have ability to generate antipathogenic substances having selective action.

A PR protein and the like have been known as such antipathogenic substances (PRPs, EP-A-0 392 225). Such antipathogenic substances and genetically engineered crops that generate them are described in EP-A-0 392 225, WO 95/33818, EP-A-0 353 191, etc.

Examples of such antipathogenic substances expressed in genetically engineered crops include: ion channel inhibitors such as a sodium channel inhibitor or a calcium channel inhibitor (KP1, KP4 and KP6 toxins, etc., which are produced by viruses, have been known); stilbene synthase; bibenzyl synthase; chitinase; glucanase; a PR protein; and antipathogenic substances generated by microorganisms, such as a peptide antibiotic, an antibiotic having a hetero ring, a protein factor associated with resistance to plant diseases (which is called a plant disease-resistant gene and is described in WO 03/000906). These antipathogenic substances and genetically engineered plants producing such substances are described in EP-A-0392225, WO95/33818, EP-A-0353191, etc.

The “plant” mentioned above includes plants on which advantageous characters such as characters improved in oil stuff ingredients or characters having reinforced amino acid content have been conferred by genetically engineering technology. Examples thereof include VISTIVE (registered trademark) low linolenic soybean having reduced linolenic content) or high-lysine (high-oil) corn (corn with increased lysine or oil content).

Stack varieties are also included in which a plurality of advantageous characters such as the classic herbicide characters mentioned above or herbicide tolerance genes, harmful insect resistance genes, antipathogenic substance producing genes, characters improved in oil stuff ingredients or characters having reinforced amino acid content are combined.

In the present invention, it is possible to use, as indicators of the water stress, plant phenotypes such as (1) germination percentage, (2) seedling establishment rate, (3) number of healthy leaves, (4) plant length, (5) plant weight, (6) leaf area, (7) leaf color, (8) number or weight of seeds or fruits, (9) quality of harvests, (10) flower setting rate or fruit setting rate, (11) chlorophyll fluorescence yield, (12) water content, (13) leaf surface temperature and (14) transpiration capacity.

The indicators can be measured in the following manner.

### (1) Germination Percentage

Seeds of plants are sown, for example, in the soil, on a filter paper, on an agar culture medium or on sand, and allowed to undergo germination, and then the ratio of the number of germinations to the number of seeds is examined.

### (2) Seedling Establishment Rate

Seeds of plants are sown, for example, in the soil, on a filter paper, on an agar culture medium or on sand, and then allowed to undergo cultivation for a given period of time. During the entire or partial cultivation period, water stress is applied, and the percentage of surviving seedlings is examined.

### (3) Number of Healthy Leaves

With respect to each of plants, the number of healthy leaves is counted and the total number of healthy leaves is examined. Alternatively, the ratio of the number of healthy leaves to the number of all leaves of plants is examined.

### (4) Plant Length

With respect to each of plants, the length from the base of the stem of the above-ground part to the branches and leaves at the tip is measured.

### (5) Plant Weight

The above-ground part of each of plants is cut and the weight is measured to determine a fresh weight of plants. Alternatively, the cut sample is dried and the weight is measured to determine a dry weight of plants.

### (6) Leaf Area

A photograph of plants is taken by a digital camera and the area of a green portion in the photograph is determined by image analysis software, for example, Win ROOF (manufactured by MITANI CORPORATION) to obtain a leaf area of plants.

### (7) Leaf Color

After sampling leaves of plants, the chlorophyll content is measured using a chlorophyll gauge (for example, SPAD-502, manufactured by Konica Minolta Holdings, Inc.) to determine the leaf color.

### (8) Number or Weight of Seeds or Fruits

After cultivating plants until they bear fruits or fruits reach full maturity, the number of fruits per plant or the total fruit weight per plant is measured. After cultivating plants until seeds undergo ripening, elements constituting the yield, such as the number of ears, ripening rate and thousand kernel weight are examined.

### (9) Quality of Harvests

After cultivating plants until fruits reach full maturity, the quality of harvests is evaluated, for example, by measuring the sugar content of fully matured fruits using a saccharimeter.

### (10) Flower Setting Rate, Fruit Setting Rate

After cultivating plants until they bear fruits, the number of flower setting and the number of fruit setting are counted to determine the fruit setting rate % (100×number of fruit setting/number of flower setting).

### (11) Chlorophyll Fluorescence Yield

By using a pulse modulation chlorophyll fluorometer (for example, IMAGING-PAM manufactured by WALZ Company), the chlorophyll fluorescence (Fv/Fm) of plants is determined to obtain the chlorophyll fluorescence yield.

### (12) Water Content

In the respective growth stages of plants, in accordance with the method described in “(5) plant weight”, the fresh weight of plants and the dry weight of plants are determined and the value obtained by subtracting the dry weight of plants from the fresh weight of plants is calculated as the water content of plants. After near infrared irradiation, the water content of plants is nondestructively measured by measuring the absorption amount (transmission amount) at this specific wavelength. For example, the water content is measured by using Scanalyzer (manufactured by LemnaTec).

### (13) Leaf Surface Temperature

In the respective growth stages of plants, the leaf surface temperature is monitored by using thermography (for example, TVS-8000 MKII, manufactured by AVIONICS).

### (14) Transpiration Capacity

In the respective growth stages of plants, transpiration of water from the leaf surface is measured by using a porometer (for example, AP4, manufactured by Delta-T).

### EXAMPLES

While the present invention will be more specifically described by way of formulation examples, seed treatment examples, and test examples in the following, the present invention is not limited to the following examples. In the following examples, the part represents part by weight unless otherwise specified.

### Formulation Example 1

Fully mixed are 3.75 parts of the present compound, 14 parts of polyoxyethylene styrylphenyl ether, 6 parts of calcium dodecyl benzene sulfonate and 76.25 parts of xylene, so as to obtain an emulsion.

### Formulation Example 2

Ten (10) parts of the present compound, 35 parts of a mixture of white carbon and a polyoxyethylene alkyl ether sulfate ammonium salt (weight ratio 1:1) and 55 parts of water are mixed, and the mixture is subjected to fine grinding according to a wet grinding method, so as to obtain a flowable formulation.

### Formulation Example 3

Fifteen (15) parts of the present compound, 1.5 parts of sorbitan trioleate and 28.5 parts of an aqueous solution containing 2 parts of polyvinyl alcohol are mixed, and the mixture is subjected to fine grinding according to a wet grinding method. Thereafter, 45 parts of an aqueous solution containing 0.05 part of Xanthan gum and 0.1 part of aluminum magnesium silicate is added to the resultant mixture, and 10 parts of propylene glycol is further added thereto. The obtained mixture is blended by stirring, so as to obtain a flowable formulation.

### Formulation Example 4

Forty-five (45) parts of the present compound, 5 parts of propylene glycol (manufactured by Nacalai Tesque), 5 parts of SoprophorFLK (manufactured by Rhodia Nikka), 0.2 parts of an anti-form C emulsion (manufactured by Dow Corning), 0.3 parts of proxel GXL (manufactured by Arch Chemicals) and 49.5 parts of ion-exchange water are mixed so as to obtain a bulk slurry. One hundred and fifty (150) parts of glass beads (diameter=1 mm) are put into 100 parts of the slurry, and the slurry is ground for 2 hours while being cooled with a cooling water. After ground, the resultant is filtered to remove the glass beads and flowable formulation is obtained.

### Formulation Example 5

Mixed to obtain an AI premix are 50.5 parts of the present compound, 38.5 parts of NN kaolin clay (manufactured by Takehara Chemical Industrial), 10 parts of MorwetD425 and 1.5 parts of MorwerEFW (manufactured by Akzo Nobel Corp.). This premix is ground with a jet mill so as to obtain a powder formulation.

### Formulation Example 6

Five (5) parts of the present compound, 1 part of synthetic hydrated silicon oxide, 2 parts of calcium lignin sulfonate, 30 parts of bentonite and 62 parts of kaolin clay are fully ground and mixed, and the resultant mixture is added with water and fully kneaded, and then subjected to granulation and drying so as to obtain a granule formulation.

### Formulation Example 7

Three (3) parts of the present compound, 87 parts of kaolin clay and 10 parts of talc are fully ground and mixed so as to obtain a powder formulation.

### Formulation Example 8

Twenty-two (22) parts of the present compound, 3 parts of calcium lignin sulfonate, 2 parts of sodium lauryl sulfate and 73 parts of synthetic hydrated silicon oxide are fully ground and mixed so as to obtain wettable powders.

### Seed Treatment Example 1

An emulsion prepared as in Formulation example 1 is used for smear treatment in an amount of 500 ml per 100 kg of dried sorghum seeds using a rotary seed treatment machine (seed dresser, produced by Hans-Ulrich Hege GmbH) so as to obtain treated seeds.

### Seed Treatment Example 2

A flowable formulation prepared as in Formulation example 2 is used for smear treatment in an amount of 50 ml per 10 kg of dried rape seeds using a rotary seed treatment machine (seed dresser, produced by Hans-Ulrich Hege GmbH) so as to obtain treated seeds.

### Seed Treatment Example 3

A flowable formulation prepared as in Formulation example 3 is used for smear treatment in an amount of 40 ml per 10 kg of dried corn seeds using a rotary seed treatment machine (seed dresser, produced by Hans-Ulrich Hege GmbH) so as to obtain treated seeds.

### Seed Treatment Example 4

Five (5) parts of a flowable formulation prepared as in Formulation example 4, 5 parts of pigment BPD6135 (manufactured by Sun Chemical) and 35 parts of water are mixed to prepare a mixture. The mixture is used for smear treatment in an amount of 60 ml per 10 kg of dried cotton seeds using a rotary seed treatment machine (seed dresser, produced by Hans-Ulrich Hege GmbH) so as to obtain treated seeds.

### Seed Treatment Example 5

A powder agent prepared as in Formulation example 5 is used for powder coating treatment in an amount of 50 g per 10 kg of dried corn seeds so as to obtain treated seeds.

### Seed Treatment Example 6

A powder agent prepared as in Formulation example 7 is used for powder coating treatment in an amount of 40 g per 100 kg of dried rice seeds so as to obtain treated seeds.

### Seed Treatment Example 7

A flowable formulation prepared as in Formulation example 2 is used for smear treatment in an amount of 50 ml per 10 kg of dried soybean seeds using a rotary seed treatment machine (seed dresser, produced by Hans-Ulrich Hege GmbH) so as to obtain treated seeds.

### Seed Treatment Example 8

A flowable formulation prepared as in Formulation example 3 is used for smear treatment in an amount of 50 ml per 10 kg of dried wheat seeds using a rotary seed treatment machine (seed dresser, produced by Hans-Ulrich Hege GmbH) so as to obtain treated seeds.

### Seed Treatment Example 9

Five (5) parts of a flowable formulation prepared as in Formulation example 4, 5 parts of pigment BPD6135 (manufactured by Sun Chemical) and 35 parts of water are mixed and the resultant mixture is used for smear treatment in an amount of 70 ml per 10 kg of potato tuber pieces using a rotary seed treatment machine (seed dresser, produced by Hans-Ulrich Hege GmbH) so as to obtain treated seeds.

### Seed Treatment Example 10

Five (5) parts of a flowable formulation prepared as in Formulation example 4, 5 parts of pigment BPD6135 (manufactured by Sun Chemical) and 35 parts of water are mixed and the resultant mixture is used for smear treatment in an amount of 70 ml per 10 kg of sunflower seeds using a rotary seed treatment machine (seed dresser, produced by Hans-Ulrich Hege GmbH) so as to obtain treated seeds.

### Seed Treatment Example 11

A powder agent prepared as in Formulation example 5 is used for powder coating treatment in an amount of 40 g per 10 kg of dried sugar beet seeds so as to obtain treated seeds.

### Example 1

### Evaluation Test for Reduction of Drought Stress by Rice Seed Treatment (Plant Weight)

### <Seed Treatment>

A Blank slurry solution containing 5% (V/V) color coat red (Becker Underwood, Inc.), 5% (V/V) CF-Clear (Becker Underwood, Inc.) and 0.4% Maxim XL (Syngenta) was prepared. A sodium salt of the compound “A” was dissolved in the Blank slurry to obtain a slurry solution containing the sodium salt of the compound “A” in a concentration of 333 to 10,000 ppm. In a 50-ml centrifuge tube made of a plastic, 300 μl of the above slurry solution was added to 10 g of rice seeds (cultivar: Nipponbare), followed by stirring for 3 to 5 minutes and further drying of the seeds. As a control, seeds treated by using the Blank slurry in place of the above slurry solution were used as seeds for a non-treated group.

### <Test Plants>

On wells of a 406-well plug plate, a filter paper was placed and rice seeds subjected to the above seed treatment were sown on the filter paper. Using a two-fold diluted Kimura B water culture solution (Plant Science 119: 39-47 (1996)), cultivation was performed for 14 days under the conditions of a temperature of 28° C./23° C. (day/night), an illuminance of 8,500 1× and a day length of 12 hours to obtain test plants.

### <Drought Stress Treatment and Recovery Treatment>

Test plants (each 5 seedlings) were placed in an empty 35 ml flat-bottomed test tube (ASSIST/manufactured by Sarstedt) and then left to stand for 2 days without being capped (this was used as a test group with the drought stress conditions). As a test group without the drought stress conditions, the test plants (each 5 seedlings) were placed in a centrifuge tube filled with 10 ml of a two-fold diluted Kimura B water culture solution, and then left to stand for 2 days without being capped. After that, the plants (each 5 seedlings) were transplanted to a plastic pot (N-71-130G, manufactured by TOKAN KOGYO CO., LTD.) filled with the field soil which had been subjected to a sterilization treatment and then cultivated for 14 days under the conditions of a temperature of 28° C./23° C. (day/night), an illuminance of 8,500 1× and a day length of 12 hours while performing bottom-surface irrigation.

### <Evaluation>

After the drought stress treatment, the fresh weight of the above-ground part of the five individuals of test plants in each test group was collectively measured and an average of 3 repetitions of each test group was determined. The results are shown in Table 1. As a result, the fresh weight of the above-ground part of the test group in the present invention was apparently large as compared with the control and drought stress was reduced.

TABLE 1

| | | Amount of | Fresh weight of | Ratio to |
|---|---|---|---|---|
| | | chemical | the above- | non- |
| Drought stress | Present | (mg/g of | ground part | treated |
| conditions | compound | seeds) | (g/5 seedlings) | group (%) |
| Without | None (=Non- | 0 | 0.81 | — |
| drought stress | treated group) | | | |
| conditions | | | | |
| With drought | None (=Non- | 0 | 0.70 | 100 |
| stress | treated group) | | | |
| conditions | Compound A, | 0.01 | 0.73 | 105 |
| | Na salt | 0.1 | 0.73 | 105 |
| | | 0.25 | 0.83 | 119 |
| | | 0.3 | 0.84 | 121 |

### Example 2

### Evaluation Test for Reduction of Drought Stress by Wheat Immersion Treatment (Plant Weight)

### <Test Plants>

On wells of a 406-well plug plate, a filter paper is placed and wheat seeds (cultivar: Shiroganekomugi) are sown on the filter paper. Using a Hoagland water culture solution (Science, 52(1354): 562-564 (1920)), cultivation is performed for 7 days under the conditions of a temperature of 22° C., an illuminance of 3,650 1× and a day length of 12 hours to obtain test plants.

<Treatment with the Present Compound>

An aqueous solution having a concentration of 250,000 ppm of a sodium salt of the compound “A” is prepared and the obtained aqueous solution is added to 100 ml of the Hoagland water culture solution so as to give each test concentration to obtain a test liquid. A DMSO solution having a 1000-fold concentration of each test concentration of the compound “B” is prepared and 0.1 mL of the obtained solution is added to 100 ml of the Hoagland water culture solution to obtain a test liquid. As a control, a test liquid is prepared by adding 0.1% DMSO to the Hoagland water culture solution.

Next, 100 ml of the test liquid is charged in a plastic cup (C-AP square cup (88-200), manufactured by Chuo Kagaku Co., Ltd.) with a cap having an opened hole and the root portions of fifteen individuals of the above test plants are immersed in the test liquid. After capping in a state where the above-ground part protrudes out of the hole of the cap, the test plants are cultivated for 3 days under the conditions of a temperature of 22° C., an illuminance of 3,650 1×, and a day length of 16 hours.

### <Drought Stress Treatment and Recovery Treatment>

Test plants (each 5 seedlings) are placed in an empty 35 ml flat-bottomed test tube (ASSIST/manufactured by Sarstedt) and then leave to stand for 3 days without being capped (this is used as a test group with the drought stress conditions). As a test group without drought stress the conditions, the test plants (each 5 seedlings) are placed in a centrifuge tube filled with 10 ml of a Hoagland water culture solution, and then leave to stand for 3 days without being capped. After that, the plants (each 5 seedlings) are transplanted to a plastic pot (N-71-130G, manufactured by TOKAN KOGYO CO., LTD.) filled with the culture soil (AISAI, manufactured by Katakura Chikkarin Co., Ltd.) having been subjected to a sterilization treatment and then cultivated for 14 days under the conditions of a temperature of 26° C., an illuminance of 5,000 1× and a day length of 16 hours while performing bottom-surface irrigation. With respect to the treated plants, the fresh weight of the above-ground part of every 5 seedlings is measured (weight after drought stress treatment).

### <Evaluation>

After the drought stress treatment, the fresh weight of the above-ground part of five individuals of test plants in each test group is collectively measured and an average of 3 repetitions of each test group is determined. The fresh weight of the above-ground part of the test group in the present invention is apparently large as compared with the control and drought stress is reduced.

### Example 3

### Evaluation Test for Reduction of Drought Stress by Wheat Seed Treatment (Plant Weight and Leaf Area)

### <Seed Treatment>

A Blank slurry solution containing 5% (V/V) color coat red (Becker Underwood, Inc.), 5% (V/V) CF-Clear (Becker Underwood, Inc.) and 0.4% Maxim XL (Syngenta) is prepared. A sodium salt of the compound “A” is dissolved in the Blank slurry to prepare a slurry solution having a concentration of 385 to 11,538 ppm of a sodium salt of the compound “A”. Using a seed treating machine (HEGE11, manufactured by Hans-Ulrich Hege), seed coating is carried out by mixing 1.3 ml of the slurry solution with 50 g of wheat seeds (cultivar: Apogee) and then the seeds are dried. As a control, seeds treated by using the Blank slurry solution in place of the above slurry solution are used as seeds for non-treated group.

### <Drought Stress Treatment and Recovery Treatment>

The culture soil (AISAI, manufactured by Katakura Chikkarin Co., Ltd.) and sand dried respectively in a dryer for 1 day are mixed in a weight ratio of 1:1 and tap water is added so that the water content will become 7.5 (W/W) or 10% (W/W) and, after mixing, a plastic pot (129π860B, manufactured by Risupack Co. Ltd.) is filled with the obtained mixture. The wheat seeds treated (coated) with the present compound are sown (five individuals per pot), put in an artificial climate chamber at the conditions of a temperature of 23° C., an illuminance of 4,000 1×, a humidity of 55%, and a day length of 12 hours, which are conditions capable of applying the drought stress conditions, and then cultivated for 5 days while adjusting the water content in the pot to a given value by measuring the weight of the pot twice a day and supplementing the vaporized water. After 5 days, bottom-surface irrigation is performed and the plants are further cultivated for 6 days under the conditions free from water stress.

As a treatment without the drought stress conditions, seeds are sown in the above culture soil and then cultivated for 11 days while performing bottom-surface irrigation.

### <Evaluation>

The fresh weight of the above-ground part of five individuals of test plants in each test group is collectively measured. Also, the total leaf area of five individuals of test plants in each test group is collectively determined using WinRHIZO image analyzer (manufactured by REGENET INSTRUMENTS). The fresh weight of the above-ground part and total leaf area of the test group in the present invention are apparently large as compared with the control and drought stress is reduced.

### Example 4

### Evaluation Test for Reduction of Excessive Moisture Stress by Soybean Seed Treatment (Germination Percentage and Plant Length)

### <Test Plants>

A Blank slurry solution containing 4.5% (V/V) color coat red (Becker Underwood, Inc.) and 5% (V/V) CF-Cl is prepared. A sodium salt of the compound “A”, the compound “A”, the compound “B”, the compound “C”, the compound “D”, the compound “E”, the compound “F” or the compound “G” as the present compound is dissolved in the Blank slurry to prepare a slurry solution having a concentration of 1,000 to 30,000 ppm of the present compound. Using a seed treating machine (HEGE11, manufactured by Hans-Ulrich Hege), seed coating is carried out by mixing 0.5 ml of the slurry solution with 50 g of soybean seeds (cultivar: Sachiyutaka) and the seeds are dried. As a control, seeds treated by using the Blank slurry solution in place of the slurry solution are used as seeds for non-treated group.

### <Excessive Moisture Stress Treatment and Recovery Treatment>

To the culture soil (AISAI, manufactured by Katakura Chikkarin Co., Ltd.), tap water is added so as to adjust the water content to 40% (W/W) and, after mixing, a plastic pot (129π860B, manufactured by Risupack Co. Ltd.) is filled with the obtained mixture. The soybean seeds treated (coated) with the present compound are sown (five individuals per pot), put in an artificial climate chamber at the conditions of a temperature of 23° C., an illuminance of 4,000 1×, a humidity of 60%, and a day length of 12 hours, and then cultivated while performing bottom-surface irrigation.

As a treatment without the excessive moisture stress conditions, seeds are sown in the above culture soil and then cultivated while performing appropriate irrigation.

### <Evaluation>

The germination percentage of each test group is checked. Also, the plant length of the survival individual is measured. The germination percentage and plant length of the test group in the present invention are apparently large as compared with the control group and excessive moisture stress is reduced.

### Example 5

### Evaluation Test for Reduction of Drought Stress by Corn Seed Treatment (Plant Weight)

A Blank slurry solution containing 5% (V/V) color coat red (Becker Underwood, Inc.), 5% (V/V) CF-Clear (Becker Underwood, Inc.) and 0.4% Maxim XL (Syngenta) is prepared. A sodium salt of the compound “A”, the compound “A”, the compound “B”, the compound “C”, the compound “D”, the compound “E”, the compound “F” or the compound “G” is dissolved in the Blank slurry solution to obtain a slurry solution so that the amount of the compound will be within a range from 1 g to 30 g per 100 kg of corn seeds (cultivar: Kuromochi). In a 50 mL centrifuge tube (manufactured by Nippon Becton Dickinson Co., Ltd.), 0.48 ml of the slurry solution is charged to 20 g of corn seeds (cultivar: Kuromochi) and stirring is performed until the solution is dried thereby coating the seeds. As a control, seeds treated by using the Blank slurry solution are used as seeds for non-treated group.

After subjecting to the seed treatment, the corn seeds (each two seeds) are sown in the culture soil (AISAI) in a plastic pot (measuring 55 mm in diameter and 58 mm in length), cultivated for 4 days under the conditions of a temperature of 27° C., an illuminance of 5,000 1× and a day length of 16 hours, followed by subjecting to a test.

The culture soil (AISAI, manufactured by Katakura Chikkarin Co., Ltd.) and sand dried respectively in a dryer for 1 day are mixed in a weight ratio of 1:1 and tap water is added so as to adjust the water content to 7.5% (W/W) or 10% (W/W) and, after mixing, a plastic pot (129π860B, manufactured by Risupack Co. Ltd.) is filled with the obtained mixture. The corn seedling obtained above is transplanted (one individual per one pot), put in an artificial climate chamber at the conditions of a temperature of 27° C., an illuminance of 5,000 1×, a humidity of 55% and a day length of 16 hours and then cultivated for 7 days while adjusting the water content in the pot to a given value by measuring the weight of the pot and supplementing tap water in an amount corresponding to the vaporized water decreased as a result of vaporization. After 7 days, the corn seedling is further cultivated for 7 days under the conditions free from water stress while sufficiently irrigation.

### <Evaluation>

The fresh weight of the above-ground part of the test plants of each test group is measured. The fresh weight of the above-ground part of the test group in the present invention is apparently large as compared with the non-treated group and drought stress is reduced.

### INDUSTRIAL APPLICABILITY

Use of the method of the present invention enables reducing water stress in plants.

1. A method for reducing water stress in a plant which comprises applying an effective amount of one or more compounds selected from the group consisting of a compound represented by the formula (I) and agriculturally acceptable salts thereof to a plant that has been exposed to or to be exposed to water stress conditions: 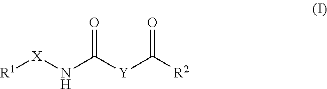
wherein
R¹ represents a phenyl group, a naphthyl group or an aromatic heterocyclic group, and these groups are optionally substituted with 1 to 5 members selected from among a halogen atom, a hydroxyl group, a cyano group, a nitro group, a C1-C6 alkyl group optionally substituted with one or more halogen atoms, a C1-C6 alkoxy group optionally substituted with one or more halogen atoms, a C1-C6 alkylthio group optionally substituted with one or more halogen atoms, a C2-C6 alkenyl group optionally substituted with one or more halogen atoms, a C2-C6 alkynyl group optionally substituted with one or more halogen atoms, an amino group, a C1-C6 alkylamino group and a di(C1-C6 alkyl)amino group;
R² represents a hydroxyl group, an amino group, or a C1-C6 alkoxy group;
X represents a linear or branched C1-C6 alkylene group; and
Y represents a linear or branched C1-C6 alkylene group, or a linear or branched C2-C6 alkenylene group.

2. The method according to claim 1, wherein in the formula (I),
R¹ is a phenyl group, a 1-naphthyl group or a 3-indolyl group, wherein one or more hydrogen atoms in these groups are optionally replaced by 1 to 5 members selected from among a halogen atom, a hydroxyl group, a nitro group, a C1-C6 alkyl group and a C1-C6 alkoxy group;
R² is a hydroxyl group, an amino group or a C1-C6 alkoxy group;
X is a linear or branched C1-C6 alkylene group; and
Y is a linear or branched C1-C6 alkylene group, or a linear or branched C2-C6 alkenylene group.

3. The method according to claim 1, wherein in the formula (I),
R¹ is a phenyl group, a 4-iodophenyl group, a 1-naphthyl group or a 3-indolyl group;
R² is a hydroxyl group or a methoxy group;
X is an ethylene group or a tetramethylene group; and
Y is an ethylene group or a trimethylene group.

4. The method according to claim 1, wherein the compound of the formula (I) is a compound selected from among the following compounds:
(1) 4-oxo-4-(2-phenylethyl)aminobutyric acid,
(2) methyl 4-oxo-4-(4-phenylbutyl)aminobutyrate,
(3) methyl 4-oxo-4-(2-phenylethyl)aminobutyrate,
(4) 4-oxo-4-(4-phenylbutyl)aminobutyric acid,
(5) 5-oxo-5-[2-(3-indolyl)ethyl]aminovaleric acid,
(6) 5-oxo-5-[(1-naphthyl)methyl]aminovaleric acid, and
(7) methyl 4-oxo-4-[2-(4-iodophenyeethyl]aminobutyrate.

5. The method according to any one of claims 1 to 4, wherein the method of the application is a seed treatment.

6. The method according to claim 5, wherein the seed treatment is a seed treatment of treating with one or more compounds selected from the group consisting of a compound represented by the formula (I) of claim 1 and agriculturally acceptable salts thereof in an amount of from 1 to 30 g per 100 kg of seeds.

7. The method according to claim 1, wherein the plant is rice, corn, soybean or wheat.

8. The method according to claim 1, wherein the plant is a transgenic plant.

9. The method according to claim 1, wherein the water stress is drought stress.

10. The method according to claim 1, wherein the water stress is excessive moisture stress.

11. The method according to claim 1, wherein the water stress is indicated by a change in one or more of the following plant phenotypes:
(1) germination percentage,
(2) seedling establishment rate,
(3) number of healthy leaves,
(4) plant length,
(5) plant weight,
(6) leaf area,
(7) leaf color,
(8) number or weight of seeds or fruits,
(9) quality of harvests,
(10) flower setting rate or fruit setting rate,
(11) chlorophyll fluorescence yield,
(12) water content,
(13) leaf surface temperature, and
(14) transpiration capacity.

12. Use of one or more compounds selected from the group consisting of the compound represented by the formula (I) of claim 1 and agriculturally acceptable salts thereof for reducing water stress in a plant.

13. The use according to claim 12, wherein the water stress is indicated by a change in one or more of the following plant phenotypes:
(1) germination percentage,
(2) seedling establishment rate,
(3) number of healthy leaves,
(4) plant length,
(5) plant weight,
(6) leaf area,
(7) leaf color,
(8) number or weight of seeds or fruits,
(9) quality of harvests,
(10) flower setting rate or fruit setting rate,
(11) chlorophyll fluorescence yield,
(12) water content,
(13) leaf surface temperature, and
(14) transpiration capacity.
